(19) United States
(12) Patent Application Publication
(10) Pub. No.: US 2002/0051631 A1
(43) Pub. Date: May 2, 2002

(54) Read-only optical disk, optical-disk playback apparatus, and optical-disk playback method

(76) Inventors: Yutaka Okamoto, Chofu-shi (JP); Hisashi Yamada, Yokohama-shi (JP); Hideo Ando, Hino-shi (JP); Chosaku Noda, Kawasaki-shi (JP); Yutaka Kashihara, Fuchu-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/915,343

(22) Filed: Jul. 27, 2001

(30) Foreign Application Priority Data
Jul. 28, 2000 (JP) 2000-229159

(51) Int. Cl. H04N 5/781; G11B 7/00

(52) U.S. Cl. 386/126; 369/124.01; 369/275.1

(57) ABSTRACT

Like a rewritable optical disk, a read-only optical disk interchangeable with a rewritable optical disk has a plurality of sector fields of a first specific length. Each of the second sector fields has a header field of a second specific length and, following the second header field, a recording field of a third specific length as in the rewritable optical disk. Each of the second recording fields has a read-only second user data recording field of a fourth specific length in a specific position as in the rewritable optical disk.

### CROSS-REFERENCE TO RELATED APPLICATIONS

This application is based upon and claims the benefit of priority from the prior Japanese Patent Application No. 2000-229159, filed Jul. 28, 2000, the entire contents of which are incorporated herein by reference.

### BACKGROUND OF THE INVENTION

1. Field of the Invention

This invention relates to a read-only optical disk characterized by high-density recording. Furthermore, this invention relates to an optical-disk playback apparatus for playing back the read-only optical disk and an optical-disk playback method.

2. Description of the Related Art

DVD (Digital Video Disk) systems have been commercialized to meet the demand for recording MPEG-2 images on one side of a 12-cm-diameter optical disk for more than two hours. According to the DVD standard, the storage capacity of a disk is 4.7 GB per side, its track density is 0.74 μm/track, its linear density is 0.267 μm/bit. Hereinafter, DVDs according to the standard are called the existing DVDs.

The information recorded on an optical disk, such as a DVD, is reproduced using an optical head. The optical head includes an LD (laser diode), an objective, a condenser lens, an optical detector. The light beam emitted from the LD is gathered by the objective onto a pit train in a track on the optical disk. The light beam reflected by the optical disk is gathered by the objective onto the optical detector. The optical detector converts the reflected light into an electric signal. The electric signal is a playback signal. The playback signal is inputted to a playback signal processing system. The resulting signal is subjected to a waveform equalizing process at an equalizer. Thereafter, the data is decoded from the playback signal. In the DVD standard, the wavelength of the LD in the optical head is 0.65 μm and the numerical aperture of the objective is 0.6.

DVDS include read-only optical disks and rewritable optical disks, which differ in data recording physical format. The existing DVDs are available in the following types: DVD-ROM, DVD-RAM, DVD-R, and DVD-RW. The data is written in the format suitable for the corresponding recording medium. Accordingly, although later commercialized DVD-RAM drives support all the formats, the early DVD-ROM drives cannot read the data from a DVD-RAM medium even if the medium is removed from the cartridge and inserted in the drive.

DVD-ROM drives of the latest model support other formats. Dealing with various formats, however, makes the mechanism and control so much more complex, which makes it impossible to reduce the production cost of drives. Moreover, it can cause users to fall into confusion, which might discourage the spread of the standard.

In the case of DVD-ROMs, address information, together with the data, is written at the head of an ECC block. For this reason, in a situation where errors occur frequently, the address information cannot be obtained until the ECC has been decoded and an error correction been made, which causes the problem of decreasing the access speed.

Although the above problem is solved by common use of the format by both read-only optical disks and rewritable optical disks, this cause another problem. Specifically, since all the data is continuous on a disk of the read-only type, a phase pull-in pattern and a control switching area are not necessary. To makes it possible to rewrite random data frequently as in a DVD-RAM, however, those areas are needed. Therefore, the common format cannot help including a phase-pull-in pattern and a control switching area. Since these patterns are not necessary for read-only disks, the format efficiency decreases.

The object of the present invention is to provide the following read-only optical disk, optical playback apparatus, and optical disk playback method:

A read-only optical disk which secures interchangeability with a rewritable disk and has excellent format efficiency, and an optical playback apparatus and an optical playback method which enables the high-speed playback of the read-only optical disk.

### BRIEF SUMMARY OF THE INVENTION

To solve the above problems and achieve the object, a read-only optical disk, optical disk playback apparatus, and optical disk playback method according to the present invention are constructed as follows.

(1) A read-only optical disk interchangeable with a rewritable optical disk characterized in that

the rewritable optical disk has a plurality of first sector fields of a first specific length arranged consecutively, each of the first sector fields having a first header field of a second specific length and, following the first header field, a first recording field of a third specific length, each of the first recording fields having a rewritable first user data recording field of a fourth specific length in a specific position, and

the read-only optical disk, like the rewritable optical disk, has a plurality of second sector fields of the first specific length arranged consecutively, each of the second sector fields, as in the rewritable optical disk, having a second header field of the second specific length and, following the second header field, a second recording field of the third specific length, each of the second recording fields, as in the rewritable optical disk, having a read-only second user data recording field of the fourth specific length in the specific position.

(2) An optical disk playback apparatus for playing pack a rewritable optical disk and a read-only optical disk interchangeable with the rewritable optical disk, the rewritable optical disk having a plurality of first sector fields of a first specific length arranged consecutively, each of the first sector fields having a first header field of a second specific length including data unique to a header field including a synchronizing pattern and, following the first header field, a first recording field of a third specific length including data unique to a recording field, each of the first recording fields having a rewritable first user data recording field of a fourth specific length in a specific position, and the read-only optical disk, like the rewritable optical disk, having a plurality of second sector fields of the first specific length arranged consecutively, each of the second sector fields having a second header field of the second specific length including data unique to a header field including the synchronizing pattern and, following the second header field, a second recording field of the third specific length including data unique to a read-only optical disk, each of the second recording fields having a read-only second user data recording field of the fourth specific length in the specific position, the optical disk playback apparatus characterized by comprising reproduction means for reproducing address data from the header field and then reproducing target data from the user data recording field in a target position on the basis of the address data.

(3) An optical disk playback method of playing pack a rewritable optical disk and a read-only optical disk interchangeable with the rewritable optical disk, the rewritable optical disk having a plurality of first sector fields of a first specific length arranged consecutively, each of the first sector fields having a first header field of a second specific length including data unique to a header field including a synchronizing pattern and, following the first header field, a first recording field of a third specific length including data unique to a recording field, each of the first recording fields having a rewritable first user data recording field of a fourth specific length in a specific position, and the read-only optical disk, like the rewritable optical disk, having a plurality of second sector fields of the first specific length arranged consecutively, each of the second sector fields having a second header field of the second specific length including data unique to a header field including the synchronizing pattern and, following the second header field, a second recording field of the third specific length including data unique to a read-only optical disk, each of the second recording field having a read-only second user data recording field of the fourth specific length in the specific position, the optical disk playback method characterized by comprising the step of reproducing address data from the header field and then reproducing target data from the user data recording field in a target position on the basis of the address data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 shows the structure of one sector field on a rewritable optical disk;

FIG. 2 shows the structure of one sector field on a read-only optical disk according to a first embodiment of the present invention;

FIG. 3 shows the structure of one sector field on a read-only optical disk according to a second embodiment of the present invention;

FIG. 4 shows the structure of one sector field on a read-only optical disk according to a third embodiment of the present invention;

FIG. 5 schematically shows option information to be recorded in an option information recording field;

FIG. 6 is a flowchart to help explain the playback control of a ROM disk having option information;

FIG. 7 shows how media identification information is recorded in an option information recording field;

FIG. 8 is a flowchart to help explain the playback control of the media identification information;

FIG. 9 shows an example of copy control information for copyright protection;

FIG. 10 is a flowchart to help explain the playback control for reproducing selectively usable additional information recorded in an option information recording field;

FIG. 11 is a flowchart to help explain the playback control for reproducing selectively usable parity information (inner parity) recorded in an option information recording field;

FIG. 12 is a flowchart to help explain the playback control for reproducing selectively usable parity information (outer parity) recorded in an option information recording field;

FIG. 13 shows the structure of one block field on a rewritable optical disk;

FIG. 14 shows the structure of one block field on a read-only optical disk according to a fourth embodiment of the present invention;

FIG. 15 shows the structure of one block field on a read-only optical disk according to a fifth embodiment of the present invention;

FIG. 16 shows the structure of one block field on a read-only optical disk according to a sixth embodiment of the present invention;

FIG. 17 shows the structure of the data in one sector on a conventional read-only optical disk medium;

FIG. 18 shows a schematic configuration of a reproducing apparatus for playing pack a read-only optical disk of the present invention explained above;

FIG. 19 is a flowchart to help explain a method of controlling a seek/tracking operation using the ID information in the header field or checking the sector addresses in a playback operation;

FIG. 20 shows a layout of tracks on a DVD-RAM;

FIG. 21 shows a layout of a sector on a DVD-RAM;

FIG. 22 shows a layout of a header on a DVD-RAM;

FIG. 23 shows the sector data recorded in the user data recording field on a DVD-RAM; and

FIG. 24 shows the ECC block data recorded in the user data recording field on a DVD-RAM.

### DETAILED DESCRIPTION OF THE INVENTION

Hereinafter, referring to the accompanying drawings, embodiments of the present invention will be explained.

DVDs include read-only optical disks and rewritable optical disks, which differ in data recording physical format.

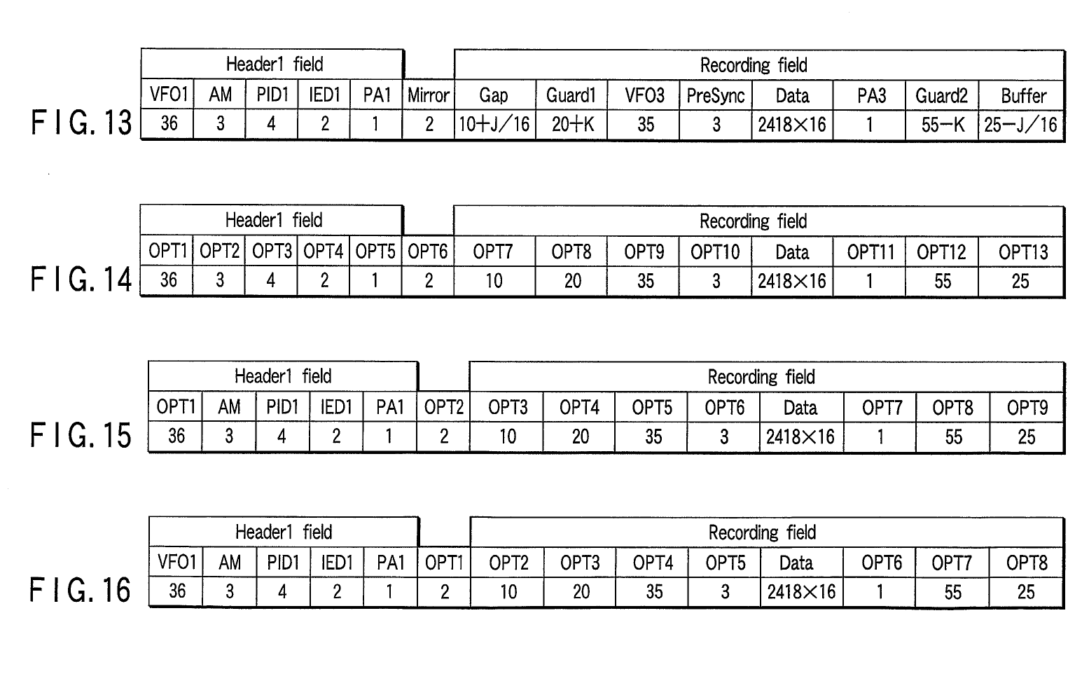

In the case of read-only optical disks, all the data is written continuously at a time on a disk, when the original disk is produced. For this reason, there is no seam connecting data items. As shown in FIG. 13, there are units called sectors in read-only optical disks. Each sector is composed of a SYNC for detecting the end of one byte of data and the data obtained through a scrambling process and modulation. There is no discontinuous point at the boundary between sectors. Around the whole disk, the signal has a constant frequency and is in phase.

To play back a read-only disk, an actuator on which an optical head is provided is first positioned near the track in which the target data has been recorded. Thereafter, the channel clock is synchronized with the phase of the playback signal using PLL. Then, byte synchronization is achieved with the SYNC area and the ID information recorded at the beginning of a sector is read. When the address for the recording area a little in front of the recording area of the desired data has been read, playback is started after the desired data has been reached. When the current address is far away from the address for the recording area of the desired data or has gone beyond, seeking is done again. In the case of a read-only disk, all the data has been written at the time of reading and the playback signal has a constant frequency and is in phase around the whole disk. This makes it easy to synchronize PLL even if there is no special pattern for increasing the gain to pull in the phase. Once the data is read out, the address information is obtained without fail. Since read-only disks are used mainly to reproduce a large amount of data, Limits on pull-in time are not strict.

Rewritable DVDs include DVD-RAMs, DVD-Rs, and DVD-RWs. Of these, DVD-RAMS are also used as secondary storage devices of computers as magnetic disks. The physical formats for the rewritable DVDs are different from those for read-only optical disks.

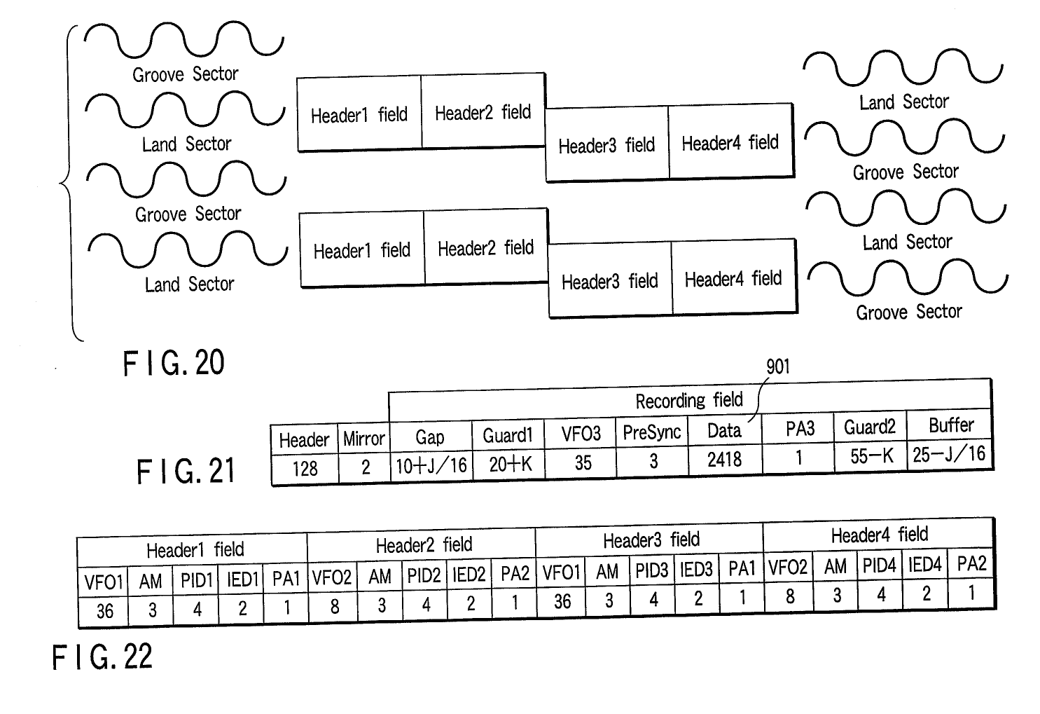

In the case of DVD-RAMs, sectors have the formats as shown in FIGS. 20 to 22.

FIG. 20 shows a layout of tracks on a DVD-RAM. A sector, the smallest unit in which data is recorded or reproduced, is made up of a header field formed in pre-pits and a recording field in which user data is recorded in marks. In the case of DVD-RAMS, the recording field is such that land tracks and groove tracks are arranged alternately.

FIG. 21 shows a layout of a sector and FIG. 22 shows a layout of a header field. In the case of DVD-RAMs, rewriting can be done physically in sectors. Since the boundary between sectors is a discontinuous point, there is an area serving as a connection.

One header field is composed of VFO, AM, PID, IED, and PA. VFO is a pattern for bit-synchronizing a Variable Frequency Oscillator, part of the PLL of the apparatus, to pull in the frequency and phase, thereby recovering the channel clock. AM (Address Mark) is a pattern for byte-synchronizing the data string in phase with one another by VFO. In PID (Physical ID), information about sectors and sector numbers have been recorded. IED (ID Error Detection code) is an error detection code for the ID part. PA is Postamble.

Since the contents of the user data area 901 coincide with those in a read-only disk, it is possible to get the address information from the beginning of the user data in the part where the data has been written. The address information, however, is not guaranteed to exist in the unrecorded part. At the beginning of each sector, the ID information has been written in pre-pits impossible to rewrite, in such a manner that the address information can be get even when no data has been recorded. Since the frequency and phase of the ID part do not necessarily coincide with those of the rewritable data part, depending on the state of writing, a synchronizing pattern (VFO) for pulling in PLL at high speed exists at the beginning of each area.

Since DVD-RAMs require Gap areas, ID areas, and synchronization patterns (VFO) for connection, they have a lower format efficiency than that of read-only disks.

The recording field is composed of GAP, Guard1, VFO, PS, Data field, PA, Guard2, and Buffer. GAP is a field for gaining the time required to change to the write mode since the sector was judged to be the target sector after the header field was read. Guard1 field is an adjusting/buffer field used together with the GAP field to avoid the destruction of the medium because rewriting the data from the same place many times would destroy the medium. VFO is a pattern for pulling PLL into the phase of the data field and recovering the channel clock. PS is a pattern for byte-synchronizing the data string whose phase has been pulled in. In the Data field, Data ID, ID error detection code, and error detection code are recorded together with the user data.

Rewritable DVDs of an another type include DVD-Rs and DVD-RWS. The number of writes onto a DVD-R is one and the number of rewritable times on a DVD-RW is 1000, which are smaller than 100,000 rewritable times on a DVD-RAM. DVD-Rs and DVD-RWs were originally developed to do trial writing before the formation of an original read-only disk. Therefore, the format in which data is recorded on DVD-Rs and DVD-RWs almost coincides with that of read-only disks. Unlike read-only disks, DVD-Rs and DVD-RWs do not guarantee that the address information exists, because data is unrecorded when the user uses the disk. In spite of this, they have no ID region provided at the beginning of each sector to acquire the address information as in a DVD-RAM. For this reason, to make it possible to acquire the address information even in an area in which no data has been written, wobbling grooves and land pre-pits are introduced.

Wobbling grooves are such that grooves for recording data are waved radially. The data is recorded in synchronization with the amplitude frequency of the wave. Land pre-pits are formed in the position synchronizing with the amplitude of the wobbling groove in the land part between grooves. Giving the address information to the pre-pits enables the address information to be obtained from an unrecorded area.

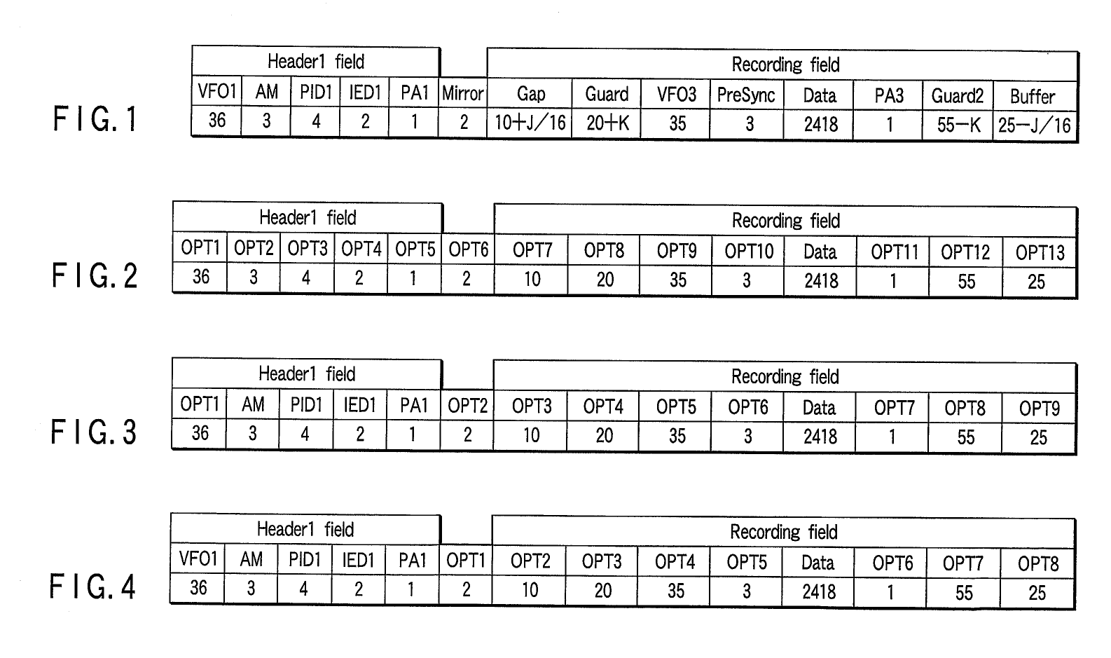

FIG. 1 shows the structure of one sector field on a rewritable optical disk. Being compared with the structure of FIG. 1, the structure of one sector field on a read-only optical disk according to one embodiment of the present invention will be explained later.

On a rewritable optical disk, a plurality of sector fields of a first specific length are arranged consecutively. As shown in FIG. 1, one sector field on the rewritable optical disk includes a header field of a second specific length, a mirror (Mirror), and a recording field (Recording field) of a third specific length. The header field is followed by the recording field, taking no account of the mirror. The header field includes VFO1, AM, PID1, IED1, and PA1. The recording field includes Gap, Guard1, VFO3, PreSync, Data (user data recording field), PA3, Guard2, and Buffer. Data in the recording field, which is a rewritable field of a fourth specific length, is provided in a specific position in the recording field.

Normally, for safety, the ID information has been written more than once in the header field (Header1 field) on a rewritable optical disk. Since the structure of each piece of ID information is the same, the structure where the ID information has been recorded only once is shown to simplify the explanation. The present invention may be applied, regardless of the number of times the ID information has been written.

FIG. 2 shows the structure of one sector field on a read-only optical disk according to a first embodiment of the present invention.

On a read-only optical disk, a plurality of sector fields of a first specific length are arranged consecutively. As shown in FIG. 2, one sector field on the read-only optical disk includes a header field of a second specific length, OP (OPTION) 6, and a recording field (Recording field) of a third specific length. The header is followed by the recording field, taking no account of OP6. The header field includes OP (OPTION) 1 to OP5. The recording field includes OP7 to OPl0, Data (user data recording field), and OP11 to OP13. Data in the recording field, which is a read-only field of a fourth specific length (containing 2418 bytes), is provided in a specific position in the recording field.

One sector field on the rewritable optical disk of FIG. 1 and one sector field on the read-only optical disk of FIG. 2 will be explained, comparing the former with the latter.

All the header field in one sector on the rewritable optical disk of FIG. 1 and each of Mirror, Gap, Guard1, VFO3, PreSync, PA3, Guard2, and Buffer are unnecessary fields for the read-only optical disk. For this reason, these fields are allocated to an option information recording field for recording the option information. As a result, a sector field on a read-only optical disk shown in FIG. 2 is obtained.

FIG. 3 shows the structure of one sector field on a read-only optical disk according to a second embodiment of the present invention.

On a read-only optical disk, a plurality of sector fields of a first specific length are arranged consecutively. As shown in FIG. 3, one sector field on the read-only optical disk includes a header field of a second specific length, OP (OPTION) 2, and a recording field (Recording field) of a third specific length. The header field is followed by the recording field, taking no account of OP2. The header field includes OP1, AM, PID1, IED1, and PA1. The recording field includes OP3 to OP6, Data (user data recording field), and OP7 to OP9. Data in the recording field, which is a read-only field of a fourth specific length, is provided in a specific position in the recording field.

One sector field on the rewritable optical disk of FIG. 1 and one sector field on the read-only optical disk of FIG. 3 will be explained, comparing the former with the latter.

All the header field in one sector on the rewritable optical disk of FIG. 1 and each of Mirror, Gap, Guard1, VFO3, PreSync, PA3, Guard2, and Buffer are unnecessary fields for the read-only optical disk. In the second embodiment, however, the header field excluding VFO is used. For this reason, in the read-only optical disk of the second embodiment, there is also allocated an option information recording field for recording option information in VFO in the header field, and in each of Mirror, Gap, Guard1, VFO3, PreSync, PA3, Guard2, and Buffer. As a result, a sector field on the read-only optical disk of FIG. 3 is obtained. In the read-only optical disk, use of the header field excluding VFO enables the ID information to be acquired from the header field, which increases the access speed.

FIG. 4 shows the structure of one sector field on a read-only optical disk according to a third embodiment of the present invention.

On a read-only optical disk, a plurality of sector fields of a first specific length are arranged consecutively. As shown in FIG. 4, one sector field on the read-only optical disk includes a header field of a second specific length, OP1, and a recording field (Recording field) of a third specific length. The header field is followed by the recording field, taking no account of OP1. The header field includes VFO, AM, PID1, IED1, and PA1. The recording field includes OP2 to OP5, Data (user data recording field), and OP6 to OP8. Data in the recording field, which is a read-only field of a fourth specific length, is provided in a specific position in the recording field.

One sector field on the rewritable optical disk of FIG. 1 and one sector field on the read-only optical disk of FIG. 4 will be explained, comparing the former with the latter.

All the header field in one sector on the rewritable optical disk of FIG. 1 and each of Mirror, Gap, Guard1, VFO3, PreSync, PA3, Guard2, and Buffer are unnecessary fields for the read-only optical disk. In the third embodiment, however, all the header field is used. For this reason, in the read-only optical disk of the third embodiment, each of Mirror, Gap, Guard1, VFO3, PreSync, PA3, Guard2, and Buffer is allocated to an option information recording field for recording option information. As a result, one sector field on the read-only optical disk of FIG. 3 is obtained. In the read-only optical disk, use of the header field enables the ID information to be acquired from the header field, which increases the access speed. In addition, use of VFO in the header field makes the clock synchronize with the header field at higher speed, which increases the access speed more.

The following is an explanation of an example of recording the information unique to the read-only optical disk into the option information recording field on the read-only optical disk of the first embodiment explained above.

In the case of the format shown in FIG. 2, there is a continuous area of 196 bytes between OPT11 in a certain sector and OPT10 in the following sector. Converting the area into the length in channel bits gives:

196(bytes)×8(bits/byte)×2

(channel bits/user bit)=3136(channel bits)

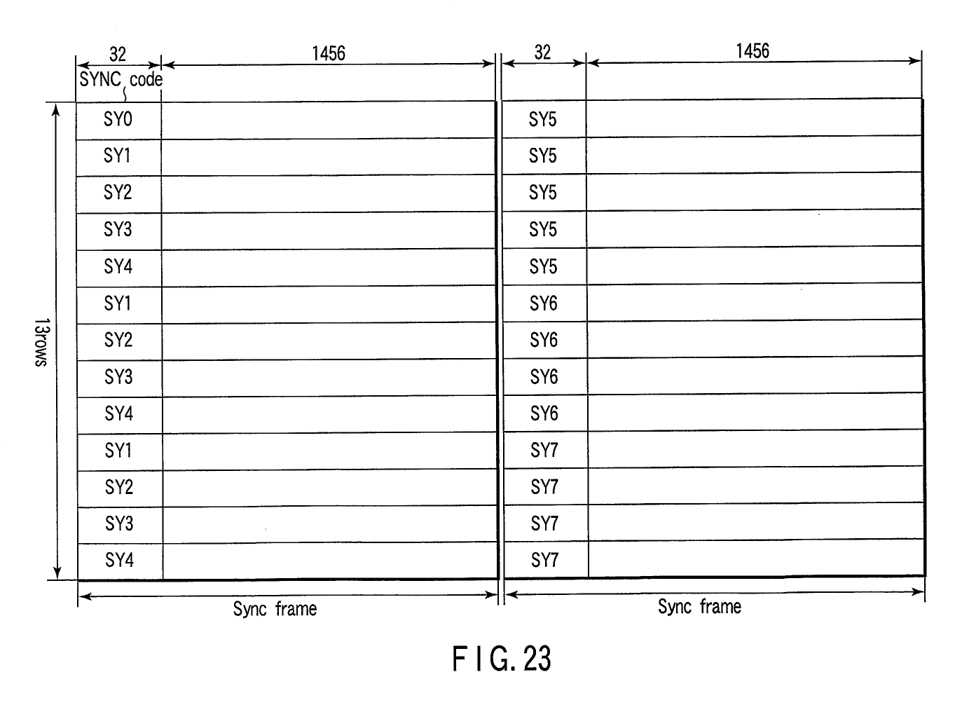

On the other hand, as shown in FIG. 23, one row of information recorded onto a DVD contains 32+1456+32+1456=2976 (channel bits). Consequently, one row of information, that is, one-thirteenth of a sector of information, can be recorded in the option information recording field of one sector.

The information in the option information recording field can be separated from the information in the conventional data recording part in a buffer of the reproducing apparatus and be made accessible as different information from a high-order apparatus. Therefore, for example, recording the bonus track unique to the ROM in the option recording field makes the body of the sector compatible with a rewritable optical disk unit at the physical format level and enables the ROM to have an advantage in terms of capacity.

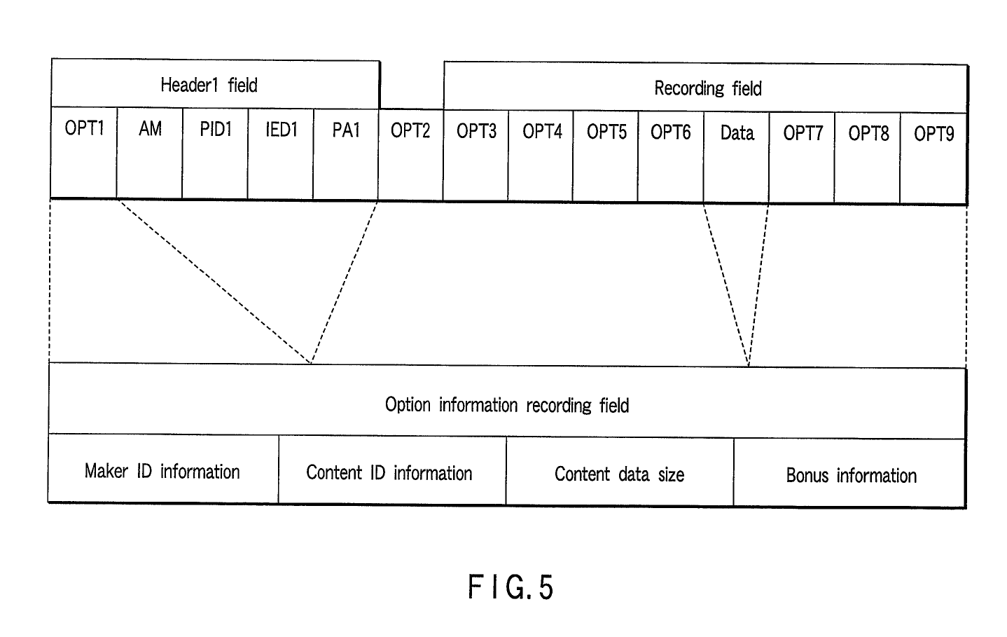

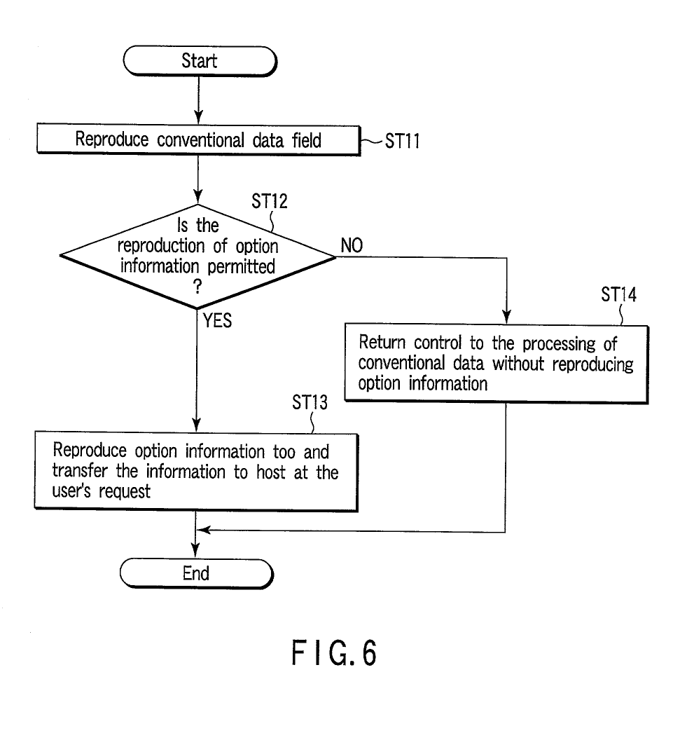

FIG. 5 schematically shows option information to be recorded in the option information recording field. FIG. 6 is a flowchart to help explain the playback control of a ROM disk having the option information. As shown in FIG. 6, a conventional data field is reproduced (ST11). If the reproduction of the option information is permitted (YES at ST12), the option information is also reproduced and the reproduced information is transferred to a host at the request of the user (ST13). If the reproduction of the option information is not permitted (NO at ST12), the option information is not reproduced and control returns to conventional data processing (ST14).

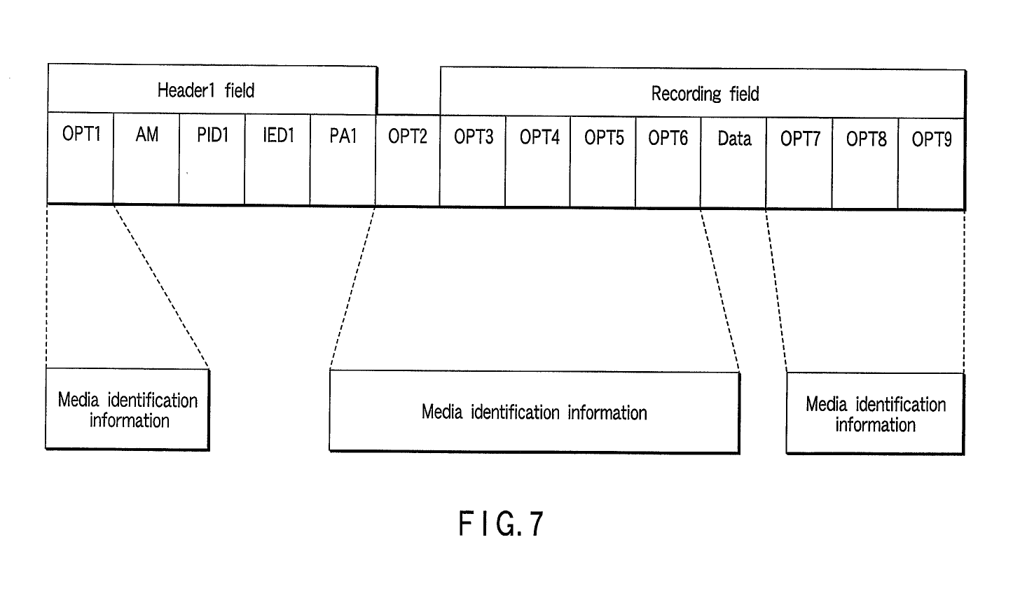

Another example of the contents recorded in the option information recording field is to record identification information by the type of medium. For example, in the case of a ROM medium, such a code as does not appear because of restrictions on modulation code is recorded in the areas ranging from OPT1 to OPT9 of FIG. 3 and used as an identification code to distinguish the ROM medium from the RAM medium. As a result, the format as shown in FIG. 7 is obtained in the case of a ROM.

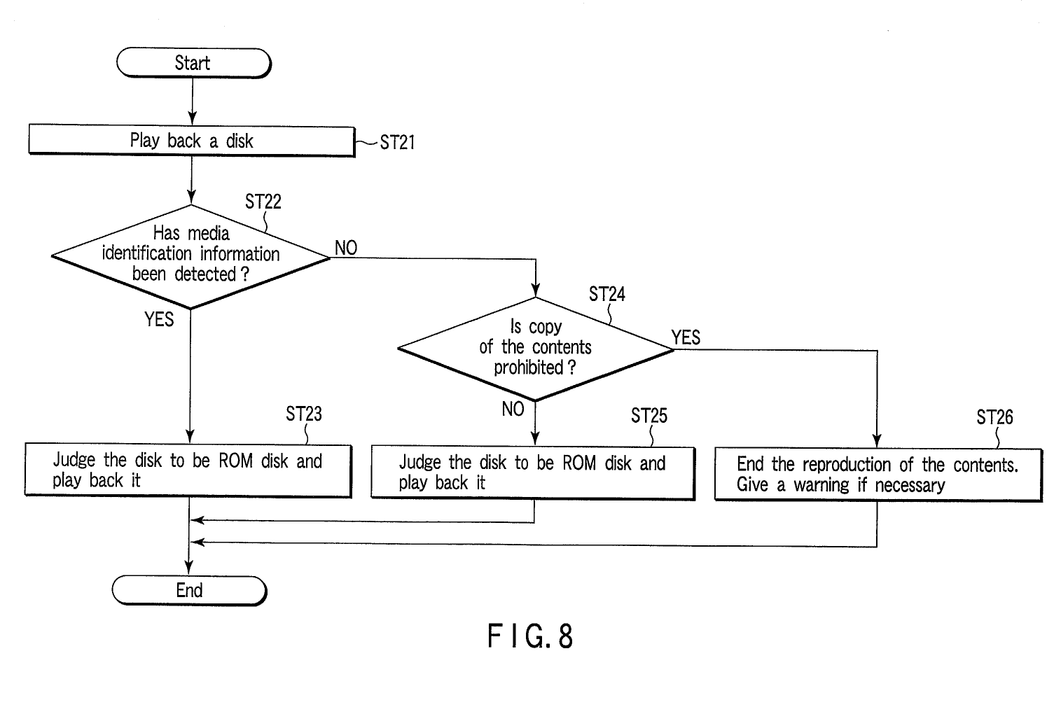

A clear distinction between ROMs and RAMs enables an unlawful copy to be detected easily even when the image of the copy-protected information on a ROM is copied onto an interchangeable recording medium (e.g., RAM) in the form of binary data images. FIG. 8 is a flowchart to help explain the playback control of the media identification information.

As shown in FIG. 8, when the disk is played back (ST21) and the media identification information is detected (ST22), the disk is judged to be a ROM disk and played back (ST23). If the media identification information is not detected (NO at ST22) and the copying of the contents is not prohibited (NO at ST24), the disk is judged to be a ROM disk and played back (ST25). If the copying of the contents is prohibited (YES at ST24), the reproducing of the contents is ended and a warning is given, if necessary (ST26).

As the option information, information on the copyright holder, information on the maker, control information to protect the copyright, or the like may be recorded in places other than the bonus track.

For instance, this approach may be used in the following application: visual content information has been encrypted with keys differing from one recording position to another; then the visual content information is decrypted and displayed in real time and displayed during reproduction, while reading the decryption keys recorded in the option information.

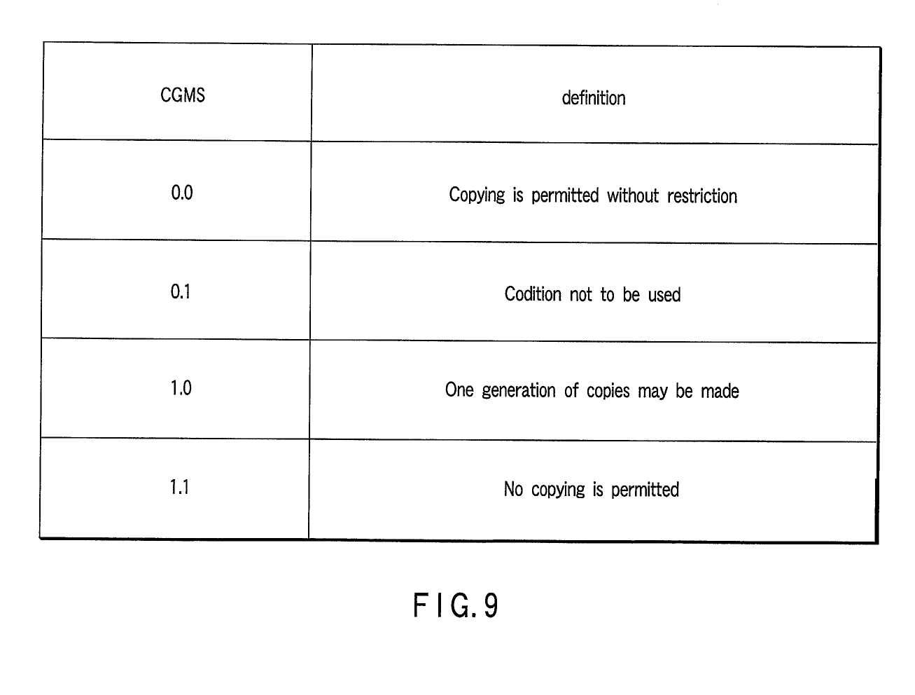

Furthermore, CGMS (Copy Generation Management System) information shown in FIG. 9 may be recorded in the copy control information for the protection of copyright and be used for copy restriction control in playback.

While in the above embodiment, such selectively usable additional information as the bonus track has been written in the option information recording field, selectively usable parity information may be recorded in a conventional data recording part.

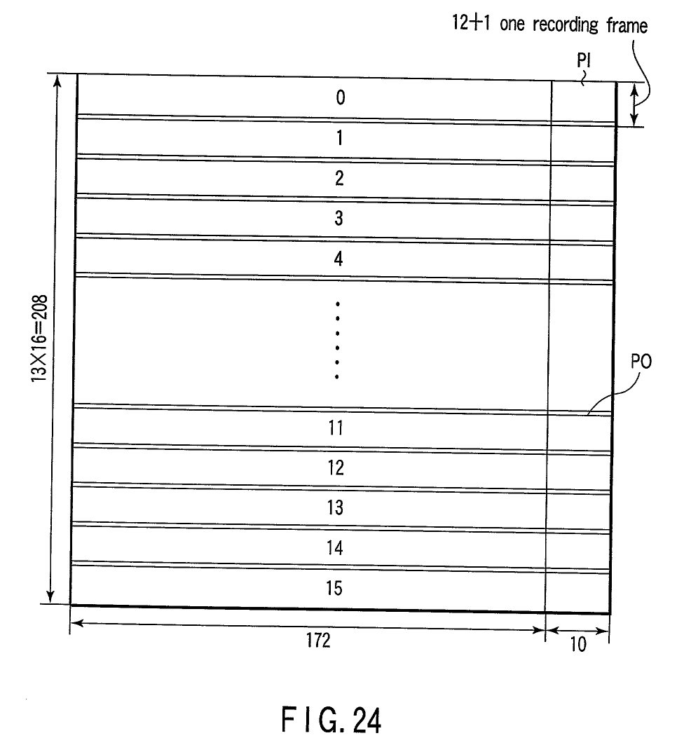

In a conventional data recording part, parity information in which 16 sectors are grouped into one ECC block is added as shown in FIG. 24. In the embodiments of the present invention, to secure the computability with a rewritable optical disk unit, additional parity information to enhance the error detecting/correcting capability is recorded in the option information recording field. In this case, as the bonus track information is recorded, the option area after the data area of a sector and the option area before the data area of the following sector may be treated as a series. Alternatively, the first-half divided option area and the second-half divided option area in the data area in the same sector may be grouped into a set, in which selectively usable parity information for the sector may be recorded.

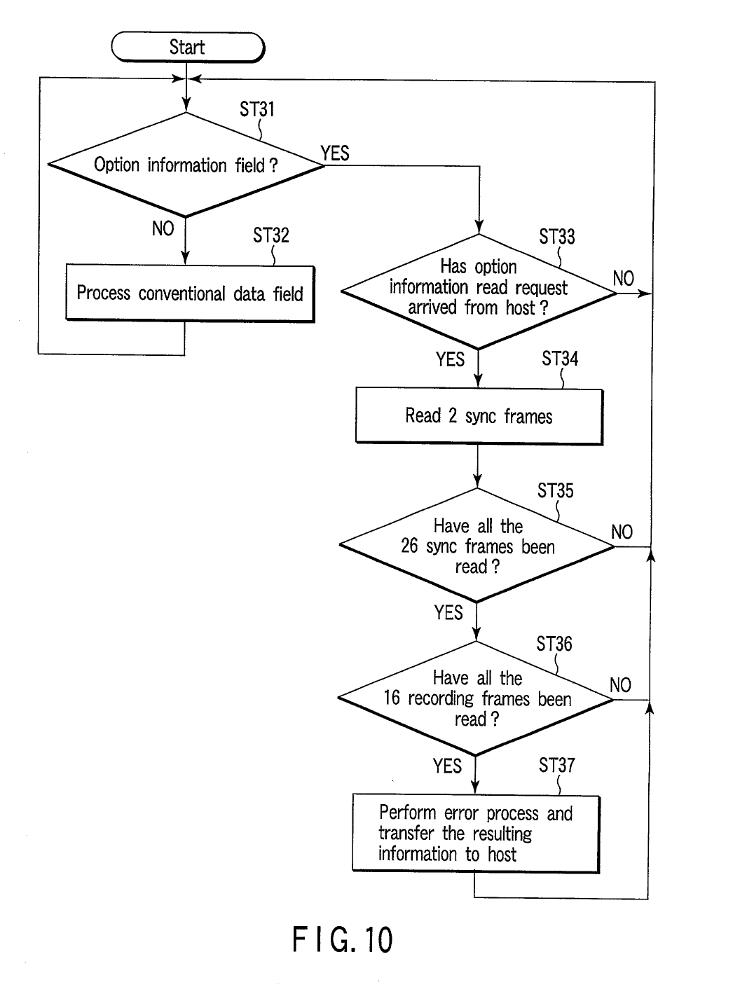

FIG. 10 is a flowchart to help explain the playback control for reproducing selectively usable additional information recorded in the option information recording field.

As shown in FIG. 10, if the field is not the option information recording field (NO at ST31), a conventional data field is processed (ST32). If the field is the option information recording field (YES at ST31), and the host has made an option information read request (YES at ST33), two SYNC frames are read (ST34). When all of the 26 SYNC frames have been read (YES at ST35) and all of the 16 recording frames have been read (YES at ST36), an error process is carried out and the resulting information is transferred to the host (ST37).

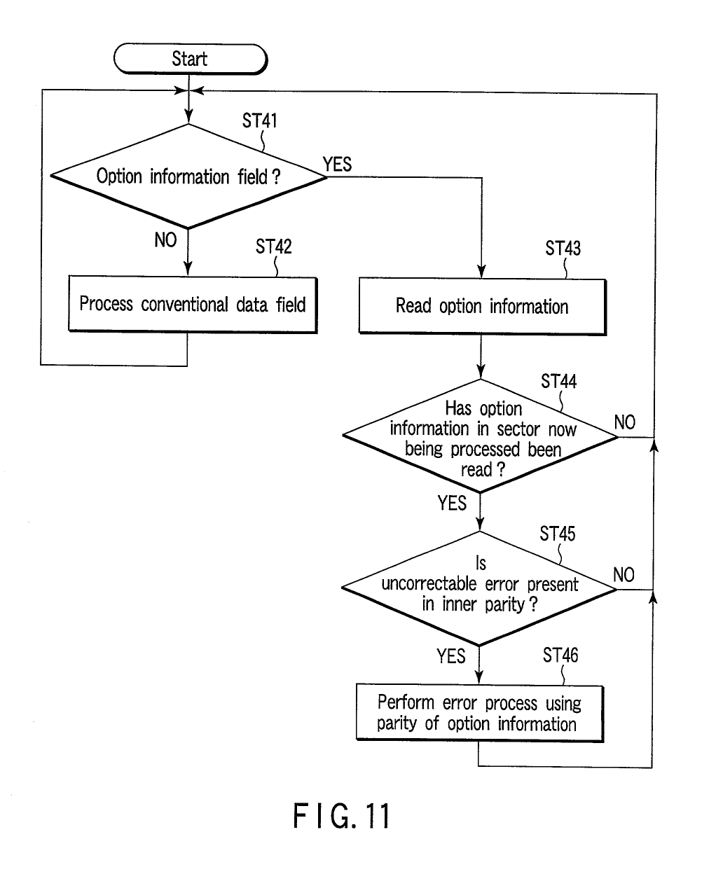

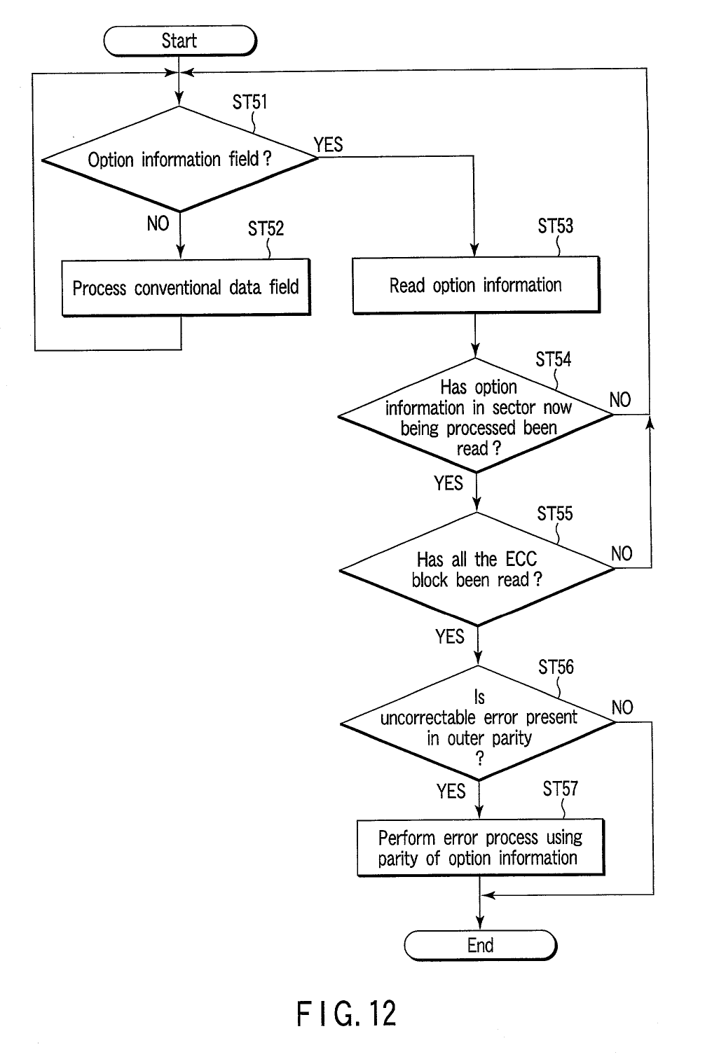

FIGS. 11 and 12 are flowcharts to help explain the playback control for reproducing selectively usable parity information (inner parity) recorded in the option information recording field. FIG. 11 shows a case where inner parity for each sector is reinforced. FIG. 12 shows a case where outer parity in an ECC block is reinforced.

As shown in FIG. 11, if the field is not the option information recording field (NO at ST41), a conventional data field is processed (ST42). If the field is the option information recording field (YES at ST41), the option information is read (ST43). When the option information in the sector being processed has been read (YES at ST44) and uncorrectable errors are present in the inner parity (YES at ST45), errors are corrected with the parity of the option information (ST46).

As shown in FIG. 12, if the field is not the option information recording field (NO at ST51), a conventional data field is processed (ST52). If the field is the option information recording field (YES at ST51), the option information is read (ST53). When the option information in the sector being processed has been read (YES at ST54), all the ECC block has been read (YES at ST55), and uncorrectable errors are present in the outer parity (YES at ST56), the errors are corrected with the parity of the option information.

FIG. 13 shows the structure of one block field on a rewritable optical disk. Being compared with the structure of FIG. 13, the structure of one block field on a read-only optical disk according to an embodiment of the present invention will be explained later.

On a rewritable optical disk, a plurality of block fields of a first specific length are arranged consecutively. As shown in FIG. 13, one block field on the rewritable optical disk includes a header field of a second specific length, a mirror (Mirror), and a recording field (Recording field) of a third specific length. The header field is followed by the recording field, taking no account of the mirror. The header field includes VFO1, AM, PID1, IED1, and PA1. The recording field includes Gap, Guard1, VFO3, PreSync, data (user data recording field), PA3, Guard2, and Buffer. Data in the recording field, which is a rewritable field of a fourth specific length, is provided in a specific position in the recording field.

Normally, for safety, the ID information has been written more than once in the header field (Header1 field) on a rewritable optical disk. Since the structure of each piece of ID information is the same, the structure where the ID information has been recorded only once is shown to simplify the explanation. The present invention may be applied, regardless of the number of times the ID information has been written.

On the existing DVD-RAMs (rewritable optical disk), a header field exists in each recording field (=1 sector) for recording 2048 bytes of user data as shown in FIG. 1. Alternatively, a format as shown in FIG. 13 can be considered where one header field exists for every 16 sectors constituting an ECC block.

FIG. 14 shows the structure of one block field on a read-only optical disk according to a fourth embodiment of the present invention.

On a read-only optical disk, a plurality of block fields of a first specific length are arranged consecutively. As shown in FIG. 14, one block field on the read-only optical disk includes a header field of a second specific length, OP (OPTION) 6, and a recording field (Recording field) of a third specific length. The header field is followed by the recording field, taking no account of OP6. The header field includes OP (OPTION) 1 to OP5. The recording field includes OP7 to OP10, Data (user data recording field), and OP11 to OP13. Data in the recording field, which is a read-only field of a fourth specific length (containing 2418×16 bytes), is provided in a specific position in the recording field.

One block field on the rewritable optical disk of FIG. 13 and one block field on the read-only optical disk of FIG. 14 will be explained, comparing the former with the latter.

All the header field in one block field on the rewritable optical disk of FIG. 13 and each of Mirror, Gap, Guard1, VFO3, PreSync, PA3, Guard2, and Buffer are unnecessary fields for the read-only optical disk. For this reason, these fields are allocated to option information recording fields for recording the option information. As a result, a block field on a read-only optical disk shown in FIG. 14 is obtained.

FIG. 15 shows the structure of one block field on a read-only optical disk according to a fifth embodiment of the present invention.

On a read-only optical disk, a plurality of block fields of a first specific length are arranged consecutively. As shown in FIG. 15, one block field on the read-only optical disk includes a header field of a second specific length, OP (OPTION) 2, and a recording field (Recording field) of a third specific length. The header field is followed by the recording field, taking no account of OP2. The header field includes OP1, AM, PID1, IED1, and PA1. The recording field includes OP3 to OP6, Data (user data recording field), and OP7 to OP9. Data in the recording field, which is a read-only field of a fourth specific length (2418×16 bytes), is provided in a specific position in the recording field.

One block field on the rewritable optical disk of FIG. 13 and one block field on the read-only optical disk of FIG. 15 will be explained, comparing the former with the latter.

All the header field in one block field on the rewritable optical disk of FIG. 13 and each of Mirror, Gap, Guard1, VFO3, PreSync, PA3, Guard2, and Buffer are unnecessary fields for the read-only optical disk. In the fifth embodiment, however, the header field excluding VFO is used. For this reason, in the read-only optical disk of the fifth embodiment, there is also allocated an option information recording field for recording option information in VFO in the header field, and in each of Mirror, Gap, Guard1, VFO3, PreSync, PA3, Guard2, and Buffer. As a result, a block field on the read-only optical disk of FIG. 15 is obtained. In the read-only optical disk, use of the header field excluding VFO enables the ID information to be acquired from the header field, which increases the access speed.

FIG. 16 shows the structure of one block field on a read-only optical disk according to a sixth embodiment of the present invention.

On a read-only optical disk, a plurality of block fields of a first specific length are arranged consecutively. As shown in FIG. 16, one block field on the read-only optical disk includes a header field of a second specific length, OP1, and a recording field (Recording field) of a third specific length. The header field is followed by the recording field, taking no account of OP1. The header field includes VFO, AM, PID1, IED1, and PA1. The recording field includes OP2 to OP5, Data (user data recording field), and OP6 to OP8. Data in the recording field, which is a read-only field of a fourth specific length (2418×16 bytes), is provided in a specific position in the recording field.

One block field on the rewritable optical disk of FIG. 13 and one block field on the read-only optical disk of FIG. 16 will be explained, comparing the former with the latter.

All the header field in one block field on the rewritable optical disk of FIG. 13 and each of Mirror, Gap, Guard1, VF03, PreSync, PA3, Guard2, and Buffer are unnecessary fields for the read-only optical disk. In the sixth embodiment, however, all the header field is used. For this reason, in the read-only optical disk of the sixth embodiment, each of Mirror, Gap, Guard1, VFO3, PreSync, PA3, Guard2, and Buffer is allocated to an option information recording field for recording option information. As a result, one block field on the read-only optical disk of FIG. 16 is obtained. In the read-only optical disk, use of the header field enables the ID information to be acquired from the header field, which increases the access speed. In addition, use of VFO in the header field makes the clock synchronize with the header field at higher speed, which increases the access speed more.

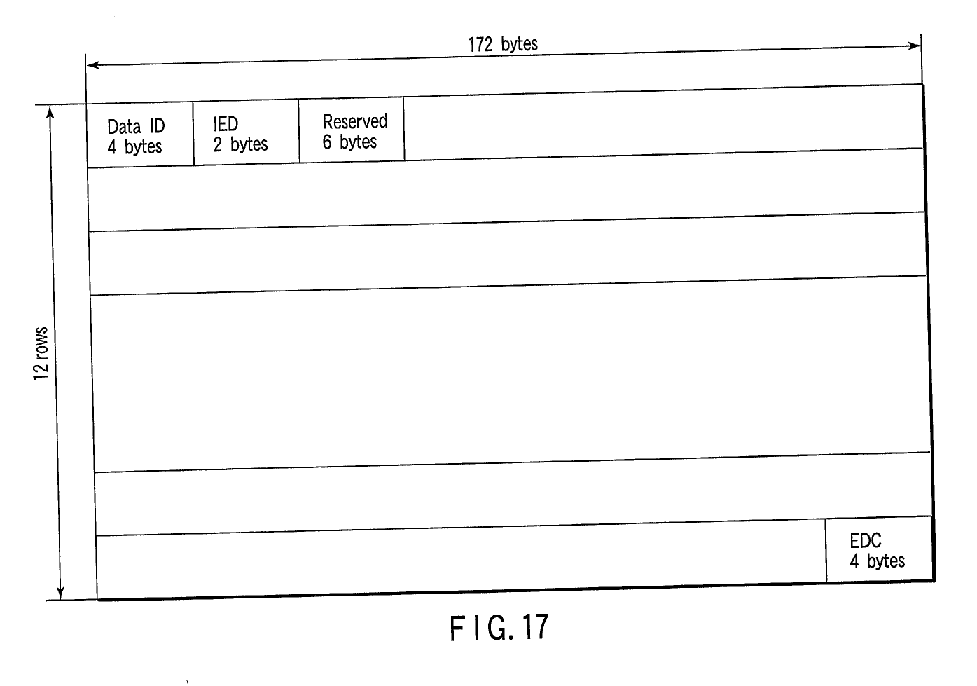

FIG. 17 shows the structure of the data in one sector on a conventional read-only optical disk medium. One sector contains 2064 bytes. The details of one sector are as follows: 2048 bytes of user data, 4-byte data ID (ID information), 2-byte ID error detection code (IED), 6-byte reserved part, and 4-byte error detection code (EDC). In this way, ID information is embedded in the data in one sector. The details of one sector containing 2418 bytes on a conventional read-only optical disk are as follows: 172-byte outer parity (PO in FIG. 24), 130-byte inner parity (PI in FIG. 24), and sync 32 (bit)×2 (units/row)×13 (row)/2 (channel bits/user data bit)/8 (bits/byte)=52 bytes.

Since the data in one sector on a conventional read-only optical disk includes the ID information, reading the ID information enables a seek/tracking operation to be controlled and the sector addresses to be checked in reproduction. In this case, however, the ID information shares error correction with the user data. Thus, when a read error has occurred and an outer parity is needed, a correction may not be made unless all the ECC blocks have been read, because the outer parity information has been recorded in such a manner it is distributed over the sectors in the ECC block.

In contrast, since the data part of the format of FIG. 15 is the same as that of a conventional format, a seek/tracking operation can be controlled and the sector addresses be checked in reproduction by the conventional method. In addition, as in the rewritable optical disk, use of the ID information in the header field enables a seek/tracking operation to be controlled and the sector addresses to be checked in reproduction.

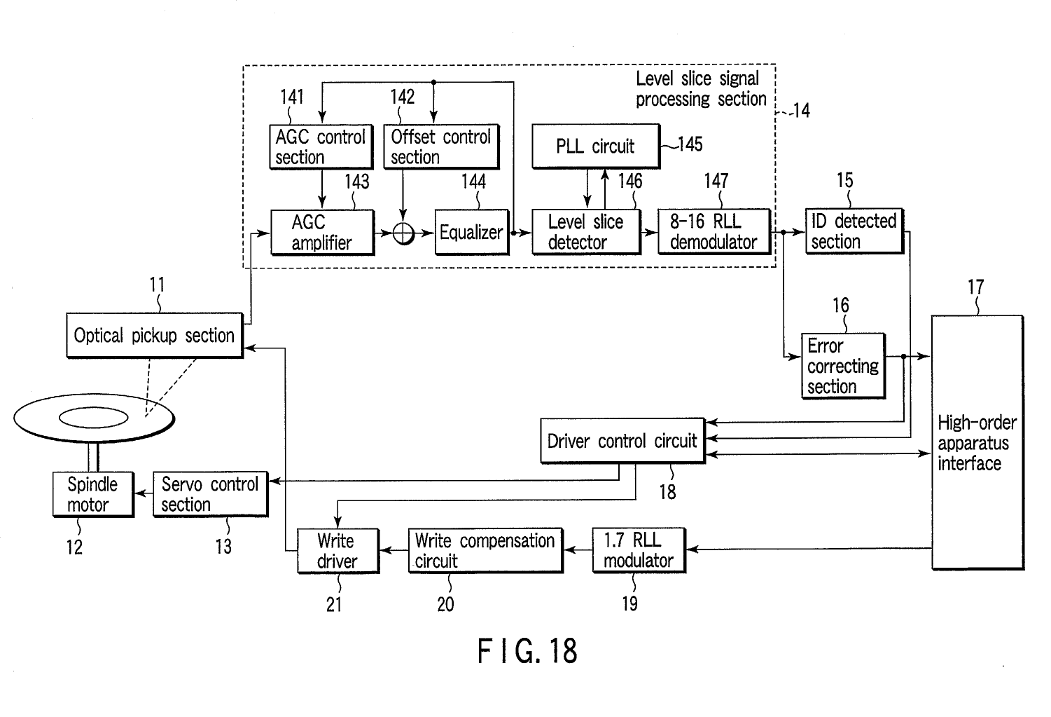

FIG. 18 shows a schematic configuration of a reproducing apparatus for playing pack a read-only optical disk of the present invention explained above. The reproducing apparatus uses the ID information in the header field on a read-only optical disk, thereby controlling a seek/tracking operation and checking the sector addresses in reproduction.

As shown in FIG. 18, the reproducing apparatus comprises an optical pickup section 11, a spindle motor 12, a servo control section 13, a level slice signal processing section 14, an ID detecting section 15, an error correcting section 16, a high-order apparatus interface 17, a drive control circuit 18, a PLL modulator 19, a write compensation circuit 20, and a write driver 21.

The optical pickup section 11 projects playback laser light or recording laser light onto an optical disk. When emitting playback laser light, the optical pickup section 11 detects the reflected laser light and offers the data on the optical disk contained in the reflected light as a playback signal. The spindle motor 12 rotates the optical disk at a specific speed. The servo control section 13 controls the tracking and focusing of the laser emitted from the optical pickup section 11. Furthermore, the servo control section 13 also controls the rotation of the spindle motor.

The level slice signal processing section 14 includes an AGC control section 141, an offset control section 142, an AGC amplifier 143, an equalizer 144, a PLL circuit 145, a slice level detector 146, and a PLL demodulator 147. The level slice signal processing section 14 subjects the playback signal offered from the optical pickup section 11 to a level slice signal process.

The ID detector 15 reads the ID information in the header field even when a read-only optical disk medium is played back as is a rewritable optical disk, and outputs the ID information to the drive control circuit 18. The drive control circuit 18 uses the ID information to control the seek/tracking operation and check the sector addresses in reproduction. Since the data part is the same as that of a conventional format, the output of the error correcting section 16 is used to control the seek/tracking operation by a conventional method. In this case, the method of checking the sector addresses in reproduction may be used at the same time.

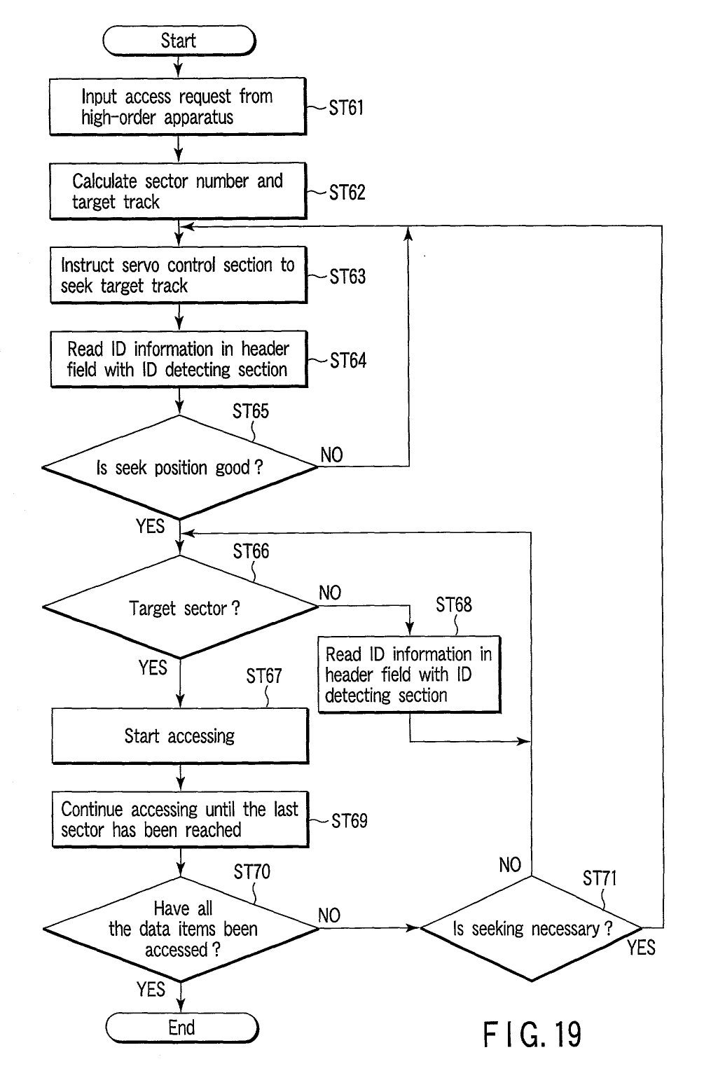

FIG. 19 is a flowchart to help explain the method of controlling the seek/tracking operation and checking the sector addresses in reproduction by use of the same ID information in the header field as that on a rewritable optical disk in the drive control section.

As shown in FIG. 19, when a high-order apparatus inputs an access request (ST61), the sector number and target track are calculated (ST62) and then, the servo control section is given an instruction to seek the target track (ST63). The ID detecting section reads the ID information in the header field (ST64). If the seek position is good (YES at ST65) and the target sector has been reached (YES at ST66), access is started. If the target sector has not been reached (NO at ST66), the ID detecting section reads the ID information in the header field (ST68). After the accessing has been started, accessing is continued until the last sector has been reached (ST69). When all the data has been accessed (YES at ST70), a series of processes has been completed. If all the data has not been accessed (NO at ST70), control will proceed to a suitable process, depending on whether the seek operation is needed or not (YES/NO at ST71).

As explained above, with the present invention, an area not contributing to read control is turned into an additional information recording area even on a read-only optical disk caused to share the format with a rewritable optical disk. This makes it possible to provide an optical disk with a high format efficiency, while securing the interchangeability with a rewritable optical disk.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A read-only optical disk interchangeable with a rewritable optical disk, wherein
said rewritable optical disk has a plurality of first sector fields of a first specific length arranged consecutively, each of said first sector fields having a first header field of a second specific length and, following the first header field, a first recording field of a third specific length, each of said first recording fields having a rewritable first user data recording field of a fourth specific length in a specific position, and
said read-only optical disk, like said rewritable optical disk, has a plurality of second sector fields of said first specific length arranged consecutively, each of said second sector fields, as in said rewritable optical disk, having a second header field of said second specific length and, following the second header field, a second recording field of said third specific length, each of said second recording fields, as in said rewritable optical disk, having a read-only second user data recording field of said fourth specific length in said specific position.

2. The read-only optical disk according to claim 1, wherein said first header field includes data unique to a header field, whereas said second header field includes data unique to a read-only optical disk, and
said first recording field includes data unique to a recording field, whereas said second recording field includes data unique to a read-only optical disk.

3. The read-only optical disk according to claim 1, wherein said first header field includes data unique to a header field, whereas said second header field includes part of the data unique to said header field and data unique to a read-only optical disk, and
said first recording field includes data unique to a recording field, whereas said second recording field includes data unique to a read-only optical disk.

4. The read-only optical disk according to claim 1, wherein said first header field includes data unique to a header field including a synchronizing pattern, whereas said second header field includes data unique to a header field excluding said synchronizing pattern and data unique to a read-only optical disk, and
said first recording field includes data unique to a recording field, whereas said second recording field includes data unique to a read-only optical disk.

5. The read-only optical disk according to claim 1, wherein said first header field includes data unique to a header field including a synchronizing pattern, whereas said second header field includes data unique to the header field including said synchronizing pattern, and
said first recording field includes data unique to a recording field, whereas said second recording field includes data unique to a read-only optical disk.

6. The read-only optical disk according to claim 2, wherein the data unique to said read-only optical disk includes parity data selectively usable to the data recorded in said second user data recording field.

7. The read-only optical disk according to claim 3, wherein the data unique to said read-only optical disk includes parity data selectively usable to the data recorded in said second user data recording field.

8. The read-only optical disk according to claim 4, wherein the data unique to said read-only optical disk includes parity data selectively usable to the data recorded in said second user data recording field.

9. The read-only optical disk according to claim 5, wherein the data unique to said read-only optical disk includes parity data selectively usable to the data recorded in said second user data recording field.

10. The read-only optical disk according to claim 2, wherein the data unique to said read-only optical disk includes selectively usable additional data.

11. The read-only optical disk according to claim 3, wherein the data unique to said read-only optical disk includes selectively usable additional data.

12. The read-only optical disk according to claim 4, wherein the data unique to said read-only optical disk includes selectively usable additional data.

13. The read-only optical disk according to claim 5, wherein the data unique to said read-only optical disk includes selectively usable additional data.

14. An optical disk playback apparatus for playing pack a rewritable optical disk and a read-only optical disk interchangeable with the rewritable optical disk, said rewritable optical disk having a plurality of first sector fields of a first specific length arranged consecutively, each of said first sector fields having a first header field of a second specific length including data unique to a header field including a synchronizing pattern and, following the first header field, a first recording field of a third specific length including data unique to a recording field, each of said first recording fields having a rewritable first user data recording field of a fourth specific length in a specific position, and said read-only optical disk, like said rewritable optical disk, having a plurality of second sector fields of said first specific length arranged consecutively, each of said second sector fields having a second header field of said second specific length including data unique to a header field including said synchronizing pattern and, following the second header field, a second recording field of said third specific length including data unique to a read-only optical disk, each of said second recording fields having a read-only second user data recording field of said fourth specific length in said specific position, said optical disk playback apparatus comprising:
reproduction means for reproducing address data from said header field and then reproducing target data from said user data recording field in a target position on the basis of the address data.

15. The optical disk playback apparatus according to claim 14, further comprising tracking control means for creating a tracking error signal from the signal reproduced by said reproduction means and controlling tracking on the basis of the tracking error signal.

16. An optical disk playback method of playing pack a rewritable optical disk and a read-only optical disk interchangeable with the rewritable optical disk, said rewritable optical disk having a plurality of first sector fields of a first specific length arranged consecutively, each of said first sector fields having a first header field of a second specific length including data unique to a header field including a synchronizing pattern and, following the first header field, a first recording field of a third specific length including data unique to a recording field, each of said first recording fields having a rewritable first user data recording field of a fourth specific length in a specific position, and said read-only optical disk, like said rewritable optical disk, having a plurality of second sector fields of said first specific length arranged consecutively, each of said second sector fields having a second header field of said second specific length including data unique to a header field including said synchronizing pattern and, following the second header field, a second recording field of said third specific length including data unique to a read-only optical disk, each of said second recording field having a read-only second user data recording field of said fourth specific length in said specific position, said optical disk playback method comprising:
the step of reproducing address data from said header field and then reproducing target data from said user data recording field in a target position on the basis of the address data.

17. The optical disk playback method according to claim 16, further comprising the step of creating a tracking error signal from the signal reproduced in said reproducing step and controlling tracking on the basis of the tracking error signal.
